(19) United States
(12) Patent Application Publication
(10) Pub. No.: US 2023/0265221 A1
(43) Pub. Date: Aug. 24, 2023

(54) CATALYSTS FOR HYDROGENATION OF AROMATIC CONTAINING POLYMERS AND USES THEREOF

(71) Applicant: SABIC Global Technologies B.V., Bergen op Zoom (NL)

(72) Inventors: Liheng WU, Sugar Land, TX (US); Dick NAGAKI, Sugar Land, TX (US); Jun WANG, Sugar Land, TX (US); Kaiwalya SABNIS, Sugar Land, TX (US); Xianghua YU, Sugar Land, TX (US); Travis CONANT, Sugar Land, TX (US); Paulette HAZIN, Sugar Land, TX (US)

(73) Assignee: SABIC Global Technologies B.V., Bergen op Zoom (NL)

(21) Appl. No.: 18/005,175

(22) PCT Filed: Jul. 13, 2021
(86) PCT No.: PCT/IB2021/056308

§ 371 Date: Jan. 11, 2023

Related U.S. Application Data
(60) Provisional application No. 63/051,687, filed on Jul. 14, 2020.

(51) Int. Cl. C08F 4/80; C08F 8/04; C08F 4/02; C08F 12/08

(52) U.S. Cl. CPC C08F 4/80; C08F 8/04; C08F 4/025; C08F 12/08

(57) ABSTRACT

Catalysts for the hydrogenation of aromatic containing polymers are described. Such a catalyst can include, based on the total weight of the catalyst, 99.1 wt. % to 99.95 wt. % of a metal oxide support, and 0.05 wt. % to 0.9 wt. % of catalytic metal nanoparticles comprising platinum (Pt), palladium (Pd), ruthenium (Ru), any combination thereof, or alloy thereof. The catalyst can have a specific surface area of 5 m²/g to 80 m²/g, a pore volume of 0.01 cm³/g to 0.35 cm³/g, and a catalyst median particle size of less than 300 microns. Processes to produce the catalyst and methods of hydrogenating aromatic containing polymers are also described.

### CROSS REFERENCE TO RELATED APPLICATIONS

This application claims the benefit of priority of U.S. Provisional Patent Application No. 63/051,687 filed Jul. 14, 2020, which is hereby incorporated by reference in its entirety.

### BACKGROUND OF THE INVENTION

### A. Field of the Invention

The invention generally concerns supported catalysts for catalytic hydrogenation of an aromatic containing polymer. The catalyst can include 0.05 wt. % to 0.9 wt. % of catalytic metal nanoparticles that include platinum, palladium, ruthenium or any combination or alloy thereof and 99.1 wt. % to 99.95 wt. % of a metal oxide support. The catalyst can have a specific surface area of 5 m²/g to 80 m²/g, a pore volume of 0.01 cm³/g to 0.35 cm³/g, and a catalyst median particle diameter (D₅₀) of less than 300 microns.

### B. Description of Related Art

Hydrogenation of aromatic polymers into saturated ones can improve their physical properties, such as thermal and mechanical properties, and oxidative stability. Homogeneous and heterogeneous catalysts can be used for this hydrogenation process. Compared to homogeneous catalysts, heterogeneous catalysts offer the advantage of separation from the polymer solutions, but can suffer from the low reaction rates due to severe mass transfer limitation caused by steric hindrances of the bulky and long polymer chains, resulting in inaccessibility of polymer molecules to the active sites. The hydrogenation of aromatic polymers has been studied using many different heterogeneous catalysts. The process continues to suffer from mass transfer limitations. To avoid the mass transfer limitation during polymer hydrogenation, non-porous CaCO₃ and BaSO₄ supports, and carbon nanotubes have been utilized. These catalyst suffer in that the low surface area and poor preparation methods resulted in low metal dispersion (typically less than 10%), leading to low catalytic activity. For example, U.S. Pat. No. 6,509,510 to Wege et al. describes a porous Pd/Al₂O₃ catalyst that has a total pore volume of 0.76 cm³/g with 96% of the pores have a pore diameter greater than 60 nm. This catalyst suffers in that it has a low hydrogenation activity of 7 moles of aromatic rings per hour per gram of Pd at 200° C. In general, the intrinsic activity of the Pd metal is low for hydrogenation reactions, which in turn requires high catalyst concentration, long reaction time, and high reaction temperature to achieve appreciable hydrogenation rates.

To improve hydrogenation rates, Pt-based catalysts have been developed. For example, U.S. Pat. No. 5,654,253 to Hucul et al. describes a 5 wt. % Pt on a porous SiO2 (i.e., a pore volume of 1.37 m³/g, surface area of 14.2 m²/g, average pore sizes between 300 and 400 nm with 98% of the pores having a diameter greater than 60 nm) for hydrogenating aromatic polymers. Kinetic studies using a porous Pt/SiO₂ catalyst show that the reaction rates for the hydrogenation of polystyrenes are strongly dependent on the molecular weight of polystyrene (Reference: Ness et al., Macromolecules 2002, 35, 602-609). For example, the hydrogenation rate using porous Pt/SiO₂ catalysts decreases significantly to 0.96×10⁻⁴ mol·L⁻¹s⁻¹ for polystyrene with the number-average molecular weight Mₙ of 200,000 g/mol compared to that (1.63×10⁻⁴ mol·L⁻¹·s⁻¹) for polystyrene with the molecular weight of 50,000 g/mol. In another example, U.S. Pat. No. 6,376,622 to Hucul et al. describes the use of SiO₂ supported catalysts for the hydrogenation of low molecular weight aromatic polymers with the Mₙ between 40,000 and 120,000 g/mol, in which the SiO₂ has pore volume larger than 1 cm³/g and over 95% of the pores having a diameter from 30 to 100 nm. In yet another example, U.S. Pat. No. 8,912,115 to Olken et al. describes a 0.96 wt. % Pt on a porous SiO₂ (i.e., a pore volume greater than 1 cm³/g, and surface area greater than 70 m²/g) that shows a hydrogenation activity of 0.280 moles of aromatic rings per hour per gram of catalyst (namely 29 moles of aromatic rings per hour per gram of Pt) at the reaction temperature of 160° C., pressure of 600 psi (4.14 MPa) in the presence of polystyrene with number-average molecular weight Mₙ of 50,000). This catalyst suffers in that it requires high metal loadings to achieve an acceptable hydrogenation activity. Challenges remain for the development of heterogeneous catalysts that should be both active and cost effective for industrial hydrogenation of unsaturated polymers with aromatic substituents on the backbone.

### SUMMARY OF THE INVENTION

A discovery has been made that provides a solution to at least one or some of the problems associated with heterogeneous polymer hydrogenation catalysts. In one aspect of the present invention, a solution can include a hydrogenation catalyst that has low catalytic metal loading on the supports. The catalysts of the present invention have a low pore volume (e.g., less than 0.4 cm³/g), a low surface area (e.g., less than 50 m²/g), and a median particle size of less than 300 microns with less than 1 wt. % loading of catalytic metal nanoparticles. The catalysts of the present invention can provide the advantage of good hydrogenation activity (e.g., greater than 10 moles of aromatic rings per hour per gram of Pt at 140° C., and greater than 20 moles of aromatic rings per hour per gram of Pt at 160° C. for hydrogenating polystyrene with the average molecular weight M_{w} of 235,000 g/mole, Polydispersity Index (PDI)=2.81) with substantially low, substantially no, or no, polymer scission. Without wishing to be bound by theory, it is believed that the catalysts structure allows enhanced interaction of the polymer with the catalytic metal on the supports and inhibits the mass transfer limitations during hydrogenation reactions.

In the context of the present invention, catalysts for hydrogenation of aromatic-containing polymers are described. Such a catalyst can include, based on the total weight of the catalyst, 99.1 wt. % to 99.95 wt. % of a metal oxide support, and 0.05 wt. % to 0.9 wt. % of catalytic metal nanoparticles comprising platinum (Pt), palladium (Pd), ruthenium (Ru), any combination thereof, or alloy thereof. The catalyst can be a heterogeneous catalyst when being used to hydrogenate aromatic-containing polymers. The catalyst can have a specific surface area of 5 m²/g to 80 m²/g, a pore volume of 0.01 cm³/g to 0.35 cm³/g, and a median particle diameter (D₅₀) of less than 300 microns, preferably less than 150 microns. In one embodiment, the catalyst can have a surface area of 5 m²/g to 20 m²/g or any range or value there between, a pore volume of 0.03 cm³/g to 0.25 cm³/g or any value or range there between, and a median particle diameter of less than 150 microns. The catalytic metal nanoparticles can have a size of 0.5 nm to 7 nm, preferably 1 nm to 4 nm, more preferably 1 nm to 2 nm. Dispersion of catalytic metal atoms on the catalytic metal nanoparticle surface can be 30% to 80%, preferably 30% to 70%, and more preferably 40% to 50%, with respect to the total metal atoms in the catalytic metal nanoparticle. A total weight of catalytic metal nanoparticles can be 0.05 wt. % to 0.90 wt. %, preferably 0.20 wt. % to 0.60 wt. %, and more preferably 0.25 wt. % to 0.50 wt. %, based on the total weight of the catalyst. In a preferred embodiment, the catalytic metal nanoparticles can be platinum (Pt) nanoparticles.

Methods for the hydrogenation of an aromatic containing polymer using the catalysts of the present invention are described. A method can include contacting a catalyst of the present invention with a polymer that includes at least one aromatic ring in the presence of hydrogen (H₂) gas under conditions sufficient to produce a polymer composition that includes at least one hydrogenated and/or at least one partially hydrogenated aromatic ring. The aromatic containing polymer can include a polystyrene group and the hydrogenated or partially hydrogenated polymer can include a poly(vinyl cyclohexane) group. The hydrogenated or partially hydrogenated polymer composition can be free or substantially free of polymer scission compositions. Contacting conditions can include a temperature of 130° C. to 200° C. or any range or value there between.

Also disclosed are processes to produce the catalysts of the present invention. A process can include contacting a slurry that includes 1) a SiO₂ or a TiO₂ metal oxide support in powder form, water, and a base (e.g., ammonium hydroxide or a metal hydroxide), or 2) a Al₂O₃ metal oxide support, water, and an acid (e.g., hydrochloric acid or nitric acid), with a catalytic metal precursor composition (e.g., platinum salt, a palladium salt, or a ruthenium salt, or a combination thereof) to produce a catalytic metal precursor/metal oxide support composition. The catalytic metal precursor/metal oxide support composition can be reduced under conditions to produce the catalysts of the present invention. The process can include drying the catalytic metal precursor/metal oxide support composition prior to the reduction step under reducing conditions that can include contacting the catalytic metal precursor/metal oxide support composition with H₂ at 150° C. to 600° C., preferably 250° C. to 450° C., more preferably 300° C. to 400° C. or any value or range there between. In some embodiments, reducing the catalytic metal precursor/metal oxide support composition can include adding a reducing agent (e.g., sodium borohydride or formaldehyde) to the catalytic metal precursor/metal oxide support composition to produce the catalyst of the present invention.

In certain aspects of the invention 20 embodiments are described. Embodiment 1 is a catalyst for the hydrogenation of an aromatic containing polymer, the catalyst comprising, based on the total weight of the catalyst: (a) 99.1 wt. % to 99.95 wt. % of a metal oxide support, and (b) 0.05 wt. % to 0.9 wt. % of catalytic metal nanoparticles comprising platinum (Pt), palladium (Pd), ruthenium (Ru), any combination thereof, or alloy thereof, wherein the catalyst has a specific surface area of 5 m²/g to 80 m²/g, a pore volume of 0.01 cm³/g to 0.35 cm³/g, and a median particle diameter of less than 300 microns. Embodiment 2 is the catalyst of embodiment 1, wherein the catalyst has a surface area of 5 m²/g to 40 m²/g, and preferably 5 m²/g to 20 m²/g. Embodiment 3 is the catalyst of any one of embodiments 1 to 2, wherein the catalyst has a pore volume of 0.03 cm³/g to 0.30 cm³/g, preferably 0.05 cm³/g to 0.25 cm³/g. Embodiment 4 is the catalyst of any one of embodiments 1 to 3, wherein the catalyst has a median particle diameter of less than 150 microns. Embodiment 5 is the catalyst of any one of embodiments 1 to 4, wherein the metal oxide support comprises silica (SiO₂), alumina (Al₂O₃), or titania (TiO₂), or any combination thereof. Embodiment 6 is the catalyst of any one of embodiments 1 to 5, wherein the catalytic metal nanoparticles have a size of 0.5 nm to 7 nm, preferably 1 nm to 4 nm, more preferably 1 nm to 2 nm. Embodiment 7 is the catalyst of any one of embodiments 1 to 6, wherein the dispersion of catalytic metal atoms on the nanoparticle surface is between on 30% to 80%, preferably 30% to 70% and more preferably 40% to 50% with respect to the total metal atoms in the nanoparticle. Embodiment 8 is the catalyst of any one of embodiments 1 to 7, wherein the catalyst comprises 0.05 wt. % to 0.8 wt. % of the catalytic metal nanoparticles, preferably 0.20 wt. % to 0.60 wt. %, and more preferably 0.25 wt. % to 0.50 wt. %, based on the total weight of the catalyst. Embodiment 9 is the catalyst of any one of embodiments 1 to 8, wherein the catalytic metal nanoparticles are Pt nanoparticles. Embodiment 10 is the catalyst of embodiment 9, wherein the metal oxide support is TiO₂. Embodiment 11 is the catalyst of embodiment 9, wherein the metal oxide support is SiO₂. Embodiment 12 is the catalyst of embodiment 9, wherein the metal oxide support is Al₂O₃.

Embodiment 13 is a method for the hydrogenation of an aromatic containing polymer, the method comprising contacting the catalyst of any one of embodiments 1 to 12 with a polymer comprising at least one aromatic ring in the presence of hydrogen (H₂) gas under conditions sufficient to produce a polymer composition comprising at least one hydrogenated and/or at least one partially hydrogenated aromatic ring. Embodiment 14 is the method of embodiment 13, wherein the aromatic containing polymer is a polystyrene and the hydrogenated or partially hydrogenated polymer comprises poly(vinyl cyclohexane), and wherein the hydrogenated or partially hydrogenated polymer composition is free or substantially free of polymer scission compositions. Embodiment 15 is the method of any one of embodiments 13 to 14, wherein contacting conditions comprise a temperature of 130° C. to 200° C., preferably 150° C. to 190° C.

Embodiment 16 is a process to produce the catalyst of any one of embodiments 1 to 12, the process comprising: (a) contacting a slurry comprising 1) SiO₂ or TiO₂ metal oxide support in powder form, water, and a base, or 2) a Al₂O₃ metal oxide support in powder form, water, and an acid, with a catalytic metal precursor composition to produce a catalytic metal precursor/metal oxide support composition; and (b) reducing the catalytic metal precursor/metal oxide support composition under conditions to produce the catalyst of any one of embodiments 1 to 12. Embodiment 17 is the process of embodiment 16, further comprising drying the catalytic metal precursor/metal oxide support composition prior to step (b) and wherein the reducing conditions comprise contacting the catalytic metal precursor/metal oxide support composition with H₂ at 150° C. to 600° C., preferably 250° C. to 450° C., more preferably 300° C. to 400° C. Embodiment 18 is the process of embodiment 17, wherein the reducing conditions comprise adding a reducing agent to the catalytic metal precursor/metal oxide support composition to produce the catalyst of any one of embodiments 1 to 12. Embodiment 19 is the process of embodiment 18, wherein the reducing agent is sodium borohydride or formaldehyde. Embodiment 20 is the process of any one of embodiments 17 to 19, wherein the catalytic metal precursor comprises a platinum salt, a palladium salt, or a ruthenium salt, and wherein the base comprises ammonium hydroxide or a metal hydroxide and the acid comprises hydrochloric acid or nitric acid.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification and the claims.

The term “aromatic-containing polymer” refers to a polymer, copolymer, block polymer and the like having at least one aromatic ring. Non-limiting examples of polymers are polystyrene, polymethylstyrene, and copolymers of styrene and at least one other monomer such as α-methylstyrene, butadiene, isoprene, acrylonitrile, methyl acrylate, methyl methacrylate, maleic anhydride and olefins such as ethylene and propylene for example. Examples of suitable copolymers include those formed from acrylonitrile, butadiene and styrene, copolymers of acrylic esters, styrene and acrylonitrile, copolymers of styrene and α-methylstyrene, and copolymers of propylene, diene and styrene, aromatic polyethers, particularly polyphenylene oxide, aromatic polycarbonates, aromatic polyesters, aromatic polyamides, polyphenylenes, polyxylylenes, polyphenylene vinylenes, polyphenylene ethinylenes, polyphenylene sulfides, polyaryl ether ketones, aromatic polysulfones, aromatic polyether sulphones, aromatic polyimides and mixtures thereof, and optionally copolymers with aliphatic compounds also. Suitable substituents in the phenyl ring include C1-C4 alkyl groups, such as methyl or ethyl, C1-C4 alkoxy groups such as methoxy or ethoxy, and aromatic entities which are condensed thereon and which are bonded to the phenyl ring via a carbon atom or via two carbon atoms, including phenyl, biphenyl and naphthyl. Suitable substituents on the vinyl group include C1-C4 alkyl groups such as methyl, ethyl, or n- or iso-propyl, particularly methyl in the α-position. Suitable olefinic comonomers include ethylene, propylene, isoprene, isobutylene, butadiene, cyclohexadiene, cyclohexene, cyclopentadiene, norbornenes which are optionally substituted, dicyclopentadienes which are optionally substituted, tetracyclododecenes which are optionally substituted, dihydrocyclopentadienes, derivatives of maleic acid, preferably maleic anhydride, and derivatives of acrylonitrile, preferably acrylonitrile and methacrylonitrile.

The aromatic-containing polymers can have (weight average) molecular weights Mw from 1000 to 10,000,000, preferably from 60,000 to 1,000,000, most preferably from 70,000 to 600,000, particularly from 100,000 to 300,000, as determined by gel permeation chromatography (GPC) equipped with light scattering, refractive index and UV detectors.

The aromatic-containing polymers can have a linear chain structure or can have branching locations due to co-units (e.g., graft copolymers). The branching centers can include star-shaped or branched polymers, or can include other geometric forms of the primary, secondary, tertiary or optionally of the quaternary polymer structure. Copolymers can be random copolymers or alternatively block copolymers. Block copolymers include di-blocks, tri-blocks, multi-blocks and star-shaped block copolymers.

The phrase “hydrogenation activity” refers to as a measured rate of polymer hydrogenation, in the unit of moles of aromatic rings per hour per gram of catalytic metal at a specific reaction temperature, pressure, and polymer concentration.

The term “nanoparticles”, means particles that exist on the nanometer (nm) scale with the diameter between 1 nm and 100 nm.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol.%,” or “mol.%” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the catalysts of the present invention are their abilities to catalyze hydrogenation of aromatic-containing polymers to fully hydrogenated or partially hydrogenated aromatic-containing polymers with substantially none or no polymer scission.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is an illustration of a reactor system to produce hydrogenated or partially hydrogenated aromatic polymers using the hydrogenation catalyst of the present invention.

FIGS. 2A and 2B are low (FIG. 2A) and high (FIG. 2B) resolution transmission electron microscope images of a catalyst of the present invention that includes Pt metal nanoparticles on a TiO₂ support at different magnifications.

FIGS. 3A and 3B are low (FIG. 3A) and high (FIG. 3B) resolution transmission electron microscope images of a catalyst of the present invention that includes Pt metal nanoparticles on a SiO₂ support.

FIGS. 4A and 4B are low (FIG. 4A) and high (FIG. 4B) resolution transmission electron microscope images of a catalyst of the present invention that includes Pt metal nanoparticles on an Al₂O₃ support.

While the invention is susceptible to various modifications and alternative forms, specific embodiments thereof are shown by way of example in the drawings. The drawings may not be to scale.

### DETAILED DESCRIPTION OF THE INVENTION

At least one solution to some of the problems associated with hydrogenating aromatic-containing polymers has been discovered. The solution can include a cost-effective catalyst that has a low catalytic metal loading on a low pore-volume support. Such a catalyst can efficiently hydrogenate or partially hydrogenate aromatic containing polymers without causing polymer scission.

These and other non-limiting aspects of the present invention are discussed in further detail in the following sections.

### A. Catalyst

The catalyst of the present invention can include a low pore volume support (pore volume less than 0.4 cm³/g) and a catalytic metal. The catalyst can have a specific surface area of at least 5 m²/g to 45 m²/g, or 5 m²/g to 40 m²/g, or 5 m²/g to 20 m²/g or 5 m²/g, 10 m²/g, 15 m²/g, 20 m²/g, 25 m²/g, 30 m²/g, 35 m²/g, 40 m²/g, or 45 m²/g, or any value or range there between. The pore volume of the catalyst can be 0.01 cm³/g to 0.35 cm³/g, or 0.03 cm³/g to 0.3 cm³/g, or 0.05 cm³/g to 0.25 cm³/g, or 0.01, 0.03, 0.05, 0.1, 0.15, 0.2, 0.25, 0.3, 0.35 cm³/g, or any value or range there between. The median particle diameter of the catalyst can be less than 300 microns, preferably less than 150 microns or 300, 250, 200, 150, 100, 50, 25, 15, 10, 1 microns or less, but greater than 0.1 micron. The catalyst has at least 50% of its pores having diameters of less than 100 nm. The support can be alumina (Al₂O₃), titania (TiO₂), silica (SiO₂), or mixtures thereof, or combinations thereof. The support can be in powder form. In a preferred embodiment, the support is not in an extrudate or a bead form. The support can have a specific surface area of at least 5 m²/g to 80 m²/g, 5 m²/g to 60 m²/g, 5 m²/g to 45 m²/g, or 5 m²/g to 40 m²/g, or 5 m²/g to 20 m²/g or 5 m²/g, 10 m²/g, 15 m²/g, 20 m²/g, 25 m²/g, 30 m²/g, 35 m²/g, 40 m²/g, 45 m²/g, 50 m²/g, 55 m²/g, 60 m²/g, 65 m²/g, 70 m²/g, 75 m²/g, or 80 m²/g, or any value or range there between. The pore volume of the support can be 0.01 cm³/g to 0.35 cm³/g, or 0.03 cm³/g to 0.3 cm³/g, or 0.05 cm³/g to 0.25 cm³/g, or 0.01, 0.03, 0.05, 0.1, 0.15, 0.2, 0.25, 0.3, 0.35 cm³/g, or any value or range there between. The median particle diameter of the support can be less than 300 microns, preferably less than 150 microns or 300, 250, 200, 150, 100, 50, 25, 15, 10, 1 microns or less, but greater than 0.1 micron. In one aspect, the support can have 1) a specific surface area of at least 5 m²/g to 80 m²/g, 5 m²/g to 60 m²/g, 5 m²/g to 45 m²/g, or 5 m²/g to 40 m²/g, or 5 m²/g to 20 m²/g or 5 m²/g, 10 m²/g, 15 m²/g, 20 m²/g, 25 m²/g, 30 m²/g, 35 m²/g, 40 m²/g, 45 m²/g, 50 m²/g, 55 m²/g, 60 m²/g, 65 m²/g, 70 m²/g, 75 m²/g, or 80 m²/g, or any value or range there between; 2) a pore volume of 0.01 cm³/g to 0.35 cm³/g, or 0.03 cm³/g to 0.3 cm³/g, or 0.05 cm³/g to 0.25 cm³/g, or 0.01, 0.03, 0.05, 0.1, 0.15, 0.2, 0.25, 0.3, 0.35 cm³/g, or any value or range there between and 3) a median particle diameter less than 300 microns, preferably less than 150 microns or 300, 250, 200, 150, 100, 50, 25, 15, 10, 1 microns or less, but greater than 0.1 micron. The support has at least 50% of its pores having diameters of less than 100 nm. Based on the total weight of the catalyst, the catalyst can include 99.1 wt. % to 99.95 wt. %, 99.75 wt. % to 99.5 wt. % or any range or value there between (e.g., 99.1, 99.2, 99.3, 99.4, 99.5, 99.6, 99.7, 99.8, 99.9, 99.95 wt. %). The amount of support will balance the amount of catalytic metal used.

The catalyst include catalytic nanoparticles that include platinum (Pt), palladium (Pd), ruthenium (Ru) or any combination thereof. The nanoparticles can be 0.5 nm to 7 nm, or 1 nm, to 4 nm, or 1 nm to 2 nm in size or any range or value there between (e.g., 0.5, 1, 1.5, 2, 2.5, 3, 3.5, 4, 4.5, 5, 5.5, 6, 6.5, or 7 nm). The dispersion of catalytic metal atoms on the nanoparticle surface is between on 30% to 80%, 30% to 70% or 40% to 50% or any range or value there between (e.g., 30%, 35%, 40%, 45%, 50%, 55%, 60%, 65%, 70%, 75%, or 80%) with respect to the total metal atoms in the nanoparticle. The total amount of catalytic metal nanoparticles, based on the total weight of catalyst, can range from 0.05 wt. % to 0.9 wt. %, or 0.2 to 0.6 wt. %, or 0.25 to 0.5 wt. %, or 0.05, 0.1, 0.2, 0.3, 0.4, 0.5, 0.6, 0.7, 0.8, 0.9, wt. % or any range or value there between. In a preferred instance, the total amount of catalytic metal can be about 0.25 to 0.5 wt. %.

In one embodiment, the catalyst can include, based on the total weight of the catalyst, 0.05 wt. % to 0.9 wt. % of Pt nanoparticles and 99.1 wt. % to 99.95 wt. % of TiO₂, 0.20 wt. % to 0.60 wt. % of Pt nanoparticles and 99.4 wt. % to 99.8 wt. % of TiO₂, or 0.25 wt. % to 0.50 wt. % of Pt nanoparticles and 99.5 wt. % to 99.75 wt. % of TiO₂. Such a catalyst has a pore volume of 0.01 cm³/g to 0.35 cm³/g, preferably 0.03 cm³/g to 0.30 cm³/g, more preferably 0.05 cm³/g to 0.25 cm³/g, a surface area of 5 m²/g to 80 m²/g, preferably 5 m²/g to 40 m²/g, more preferably 5 m²/g to 20 m²/g, and a median pore diameter of less than 300 microns, preferably less than 100 microns.

In one embodiment, the catalyst can include, based on the total weight of the catalyst, 0.05 wt. % to 0.9 wt. % of Pt nanoparticles and 99.1 wt. % to 99.95 wt. % of SiO₂, 0.20 wt. % to 0.60 wt. % of Pt nanoparticles and 99.4 wt. % to 99.8 wt. % of SiO₂, or 0.25 wt. % to 0.50 wt. % of Pt nanoparticles and 99.5 wt. % to 99.75 wt. % of SiO₂. Such a catalyst can have a pore volume of 0.01 cm³/g to 0.35 cm³/g, preferably 0.03 cm³/g to 0.30 cm³/g, more preferably 0.05 cm³/g to 0.25 cm³/g, a surface area of 5 m²/g to 802/g, preferably 5 m²/g to 40 m²/g, more preferably 5 m²/g to 20 m²/g, and a median pore diameter of less than 300 microns, preferably less than 100 microns.

In one embodiment, the catalyst can include, based on the total weight of the catalyst, 0.05 wt. % to 0.9 wt. % of Pt nanoparticles and 99.1 wt. % to 99.95 wt. % of Al₂O₃, 0.20 wt. % to 0.60 wt. % of Pt nanoparticles and 99.4 wt. % to 99.8 wt. % of Al₂O₃, or 0.25 wt. % to 0.50 wt. % of Pt nanoparticles and 99.5 wt. % to 99.75 wt. % of Al₂O₃. Such a catalyst has a pore volume of 0.01 cm³/g to 0.35 cm³/g, preferably 0.03 cm³/g to 0.30 cm³/g, more preferably 0.05 cm³/g to 0.25 cm³/g, a surface area of 5 m²/g to 80 m²/g, preferably 5 m²/g to 40 m²/g, more preferably 5 m²/g to 20 m²/g, and a median pore diameter of less than 300 microns, preferably less than 100 microns.

### B. Catalyst Preparation

The catalyst can be made using catalyst preparation methodology known to a person with skill in performing catalyst synthesis (e.g., a chemist or an engineer). Depending on the support material, a base or acid may be employed during the process of producing the catalyst. More than one method of reducing the catalyst precursor to a nanoparticle can also be used. Non-limiting examples of preparing the catalyst are described below.

### 1. SiO₂ and TiO₂ Supports, Catalytic Metal and H₂ Reduction

A catalytic metal precursor can be dissolved in deionized water to form a catalytic metal precursor solution. Catalytic metal precursors can be obtained as a metal nitrate, a metal amine, a metal chloride, a metal coordination complex, a metal sulfate, a metal phosphate hydrate, metal complex, or any combination thereof. These metals or metal compounds can be purchased from any chemical supplier such as Millipore Sigma (St. Louis, Mo., USA), Alfa-Aesar (Ward Hill, Mass., USA), and Strem Chemicals (Newburyport, Mass., USA). A non-limiting example of a metal precursor compound is tetraammineplatinum(II) chloride, tetraamineplatinum(II) nitrate, tetraamineplatinum(II) hydroxide, tetraaminepalladium(II) chloride, tetraaminepalladium(II) nitrate, hexaammineruthenium(III) chloride, or hexaammineruthenium(II) chloride. The catalytic metal precursor solution can be added to a composition that includes a known quantity of support (e.g., SiO₂ or TiO₂), water, and a base (e.g., ammonium hydroxide or sodium hydroxide) to form a catalytic metal precursor/support composition. Support materials can be obtained from commercial suppliers such as Millipore Sigma, Alfa-Aesar, Cristal, Evonik, and the like. In some embodiments, the water suspension of catalyst supports can be added to the metal precursor solution. The catalytic metal precursor/support composition can be agitated for a period of time (e.g., 0.5 to 24 hours) at ambient temperature (e.g., 20° C. to 35° C.). The catalytic metal precursor/support composition can be separated from the water using known separation techniques (e.g., filtration, centrifugation, and the like) and washed sufficiently with deionized water to remove any residual base. Residual water in the filtered catalytic metal precursor/support composition can be removed by drying the catalytic metal precursor/support composition at a temperature of 80° C. to 100° C., or about 95° C. Once dried, the dried catalytic metal precursor/support composition can be subjected to reducing conditions to convert the catalytic metal precursor to metal nanoparticles. Reducing conditions can include using H₂ balanced with N₂ with at a desired flowrate (e.g., 450 to 600 standard cubic centimeter per min) at a desired temperature. For example, a temperature rate of 5 to 10° C./min from 20° C. to 400° C. and kept at 400° C. for 0.5 to 1 hr before cooling to room temperature to produce the catalysts of the present invention.

### 2. SiO₂ and TiO₂ Supports, Catalytic Metal and Solution Reduction

A catalytic metal precursor described in Section B. la can be dissolved in deionized water to form a catalytic metal precursor solution. The catalytic metal precursor solution can be added to a composition that includes a known quantity of support (e.g., SiO₂ or TiO₂), water, and a base (e.g., ammonium hydroxide or sodium hydroxide), and agitated for a period of time (e.g., 0.5 to 24 hours) at ambient temperature (e.g., 20° C. to 35° C.) to form a catalytic metal precursor/support composition. In some embodiments, the water suspension of catalyst supports can be added to the metal precursor solution. A reducing agent such as sodium borohydride or formaldehyde dissolved in deionized water can be added dropwise into catalyst precursor/support composition and the resulting mixture can then be stirred for a desired amount of time (e.g., 1 hr to 24 hrs). A molar reducing agent to Pt ratio can be 1:1, 2:1, 3:1, 4:1, 5:1 or any value or range there between. The solid catalyst/support material can be separated from the slurry and washed with deionized water to remove excess materials (e.g., three times with deionized water). The washed solid catalyst/support material can be dried in an oven at 95° C. to produce the Pt/TiO₂ catalyst of the present invention.

### 3. Al₂O₃ Support, Catalytic Metal, and H₂ Reduction

A catalytic metal precursor can be dissolved in deionized water to form a catalytic metal precursor solution. Catalytic metal precursors can be obtained as a metal nitrate, a metal amine, a metal chloride, a metal coordination complex, a metal sulfate, a metal phosphate hydrate, metal complex, or any combination thereof. Non-limiting examples of metal precursor compounds include chloroplatinic acid, potassium hexachloroplatinate(IV), potassium tetrachloroplatinate(II), sodium hexachloroplatinate(IV), sodium tetrachloroplatinate (II), potassium hexachloropalladate(IV), potassium tetrachloropalladate(II), sodium hexachloropalladate(IV), sodium tetrachloropalladate(II), or ammonium hexachlororuthenate(IV). These metals or metal compounds can be purchased from any chemical supplier such as Millipore Sigma (St. Louis, Mo., USA), Alfa-Aesar (Ward Hill, Mass., USA), and Strem Chemicals (Newburyport, Mass., USA). The catalytic metal precursor solution can be added to a composition that includes a known quantity of Al₂O₃, water, and a mineral acid (e.g., hydrochloric acid or nitric acid) and, then, agitated for a period of time (e.g., 0.5 to 24 hours) at ambient temperature (e.g., 20° C. to 35° C.) to form a catalytic metal precursor/Al₂O₃ composition. It should be understood that the order of addition of the catalyst and support solutions can be reversed. Al₂O₃ can be obtained from commercial suppliers such as Alfa-Aesar, Millipore Sigma, and the like. The catalytic metal precursor/ Al₂O₃ composition can be separated from the water using known separation techniques (e.g., filtration, centrifugation, and the like) and washed sufficiently with deionized water to remove any residual acid. Water in the filtered catalytic metal precursor/Al₂O₃ composition can be removed by drying the catalytic metal precursor/Al₂O₃ composition at a temperature of 80° C. to 100° C., or about 95° C. Once dried, the dried catalytic metal precursor/Al₂O₃ composition can be subjected to reducing conditions to convert the catalytic metal precursor to metal nanoparticles. Reducing condition can include using H₂ balanced N₂ with at a desired flowrate (e.g., 450 to 600 standard cubic centimeter per min) at a desired temperature. For example, a temperature rate of 5 to 10° C./min from 20° C. to 400° C. and kept at 400° C. for 0.5 to 1 hr before cooling to room temperature to produce the Al₂O₃ supported catalysts of the present invention.

### C. Methods of Hydrogenating Aromatic-Containing Polymers

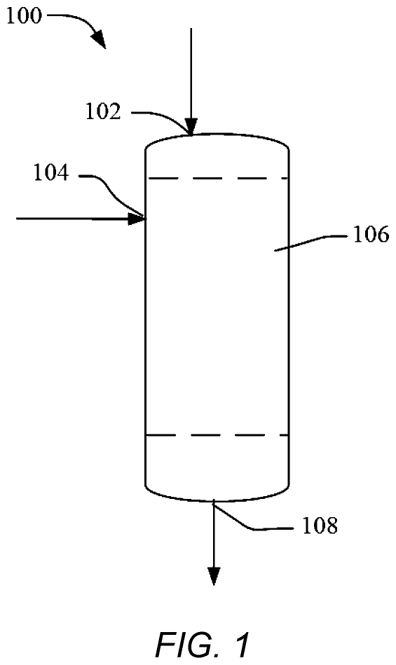

FIG. 1 depicts a schematic for a process for the hydrogenation of an aromatic-containing polymer using the catalyst(s) of the present invention. Reactor 100 can include inlet 102 for a polymer reactant feed, inlet 104 for H₂ reactant feed, reaction zone 106 that is configured to be in fluid communication with the inlets 102 and 104, and outlet 108 configured to be in fluid communication with the reaction zone 106 and configured to remove the product stream (e.g., hydrogenated or partially hydrogenated aromatic containing polymer) from the reaction zone. Reactor 100 can be any reactor suitable for performing polymer hydrogenations (e.g., a batch reactor or continuous reactor). Reaction zone 106 can include the hydrogenation catalyst of the present invention. The polymer reactant feed can enter reaction zone 106 via inlet 102. The reactant feed can be a mixture of solvent (e.g., cyclohexane or decahydronaphthalene) and polymer. A mass ratio of solvent to polymer can be 4:1, 9:1, 19:1 or any range or value there between. The H₂ reactant feed can enter reactor 100 after purging the reactor with nitrogen via inlet 104. Pressure of reactor 100 can be maintained with the H₂ reactant feed. The product stream can be removed from the reaction zone 106 via product outlet 108. The product stream can be sent to other processing units, stored, and/or be transported.

Reactor 100 can include one or more heating and/or cooling devices (e.g., insulation, electrical heaters, jacketed heat exchangers in the wall) or controllers (e.g., computers, flow valves, automated values, etc.) that can be used to control the reaction temperature and pressure of the reaction mixture. While only one reactor is shown, it should be understood that multiple reactors can be housed in one unit or a plurality of reactors housed in one heat transfer unit. In some embodiments, a series of physically separated reactors with interstage cooling/heating devices, including heat exchangers, furnaces, fired heaters, and the like can be used.

The temperature and pressure can be varied depending on the reaction to be performed and is within the skill of a person performing the reaction (e.g., an engineer or chemist). Temperatures can range from 130° C. to about 200° C., 140° C. to 190° C., 150° C. to 180° C., or any value or range there between. H₂ pressures can range from about 3.45 MPa to 7 MPa or 3.45, 3.5, 3.6, 3.7, 3.8, 3.9, 4.0, 4.1, 4.2, 4.3, 4.5, 5.0, 5.5, 6.0, 6.5, or 7.0 or any range or value there between.

The product stream can include at least one hydrogenated, at least one partially hydrogenated aromatic ring, or both, or mixtures thereof. For example, polystyrene can be hydrogenated to produce poly(vinylcyclohexane). The produced polymer product is absent lower molecular weight polymers due to polymer scission. The hydrogenation activity can be at least 10 moles of aromatic rings per hour per gram of catalytic metal (e.g., Pt, Pd, and/or Ru) at the reaction temperature of 140° C., pressure of 6.9 MPa, and polymer concentration of 8 wt %. Hydrogenation level can be at least 90%.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Testing Methodology and Instrumentation

Brunauer-Emmett-Teller (BET) N₂-adsorption measurements were performed at 77 K on a Quantachrome Autosorb-6iSA analyzer to characterize the surface area and pore volume. Particle size analysis of the supports was performed on a Malvern Panalytical Zetasizer Dynamic Light Scattering (DLS) instrument. The amount of catalytic metal in the catalysts of the present invention was determined using inductively coupled plasma atomic emission spectroscopy (ICP-AES) on a PerkinElmer Optima 8300 ICP-OES Spectrometer. The catalytic metal was dissolved by aqua regia, followed by dilution with deionized H₂O and filtration to remove the solid support to obtain a clear metal solution. The metal nanoparticles were characterized by transmission electron microscopy using an FEI Tecnai F20 TEM operating at 200 keV. TEM samples of the catalysts were prepared through dry deposition, namely slight shaking a lacey-carbon Cu-mesh TEM grid within the catalyst powder in a glass vial. The metal dispersion in the metal nanoparticles was measured by static H₂-O₂ titration technique. The H₂ chemisorption experiments were performed on a Micrometrics 3Flex instrument. Approximately 600 mg of the catalyst powder was loaded in a quartz tube and subjected to pretreatment that consisted of H₂ reduction (50 standard cubic centimeter per minute) at 200° C. for 4 hr, followed by evacuation at 200° C. for 4 hr and cooling down to 35° C. under evacuation for another 30 min. Then, O₂ was admitted to the catalyst at 35° C. and 1 atm to contact the catalyst for 60 min. After evacuating the O₂ out at 35° C. for 1 hr, the first H₂ uptake was measured over a pressure range at 35° C. by H₂ adsorption isotherm. After evacuating the H₂ out at the same temperature, the second H₂ uptake was measured at the same condition as the first H₂ adsorption isotherm. The amount of chemisorbed H₂ was calculated from difference between the first H₂ uptake and the second H₂ uptake. Because the reaction PtO (surface)+3/2 H₂→PtH (surface)+H₂O took place, the stoichiometry of 3:1 for the adsorbed H atom and the surface Pt atom was used. The metal dispersion was normalized by the surface metal atoms over the total metal atoms in the catalysts measured from ICP analysis.

### Examples 1(a) and 1(b)

### (Synthesis of Pt on Low Pore Volume TiO₂ Catalyst)

TiO₂ (commercial TiO₂), calcined at static air at 820° C. for 5 h, surface area of 10.4 m²/g, pore volume of 0.24 cm³/g, a median particle diameter (D50) of less than 2 microns, 6 grams) was dispersed in deionized H₂O (60 mL). Ammonium hydroxide solution (30 wt. %, 0.78 mL) was added into the mixture, and the slurry stirred for 30 min.

Tetraammineplatinum(II) chloride (from 106 mg) dissolved in H₂O (2 mL) was added into the slurry and then the mixture was stirred for 1.5 hrs. The resulting catalyst precursor/support material was separated from the slurry using vacuum filtration. The solid catalyst precursor/support material was washed (3 times) with deionized water (100 mL), and then dried in a drying oven at 95° C. for 3 hours to produce the catalyst precursor/support material as a dry powder. The catalyst precursor/support dry powder was reduced in a horizontal tube furnace using 10% H₂ balanced N₂ with a total flowrate of 500 standard cubic centimeter per min under the following conditions: a temperature rate of 10° C./min from 20° C. to 400° C. and keep at 400° C. for 1 hr before cooling to room temperature to produce the Pt/TiO₂ catalysts of the present invention. The final Pt loading was determined to be 0.33 wt. % by ICP analysis.

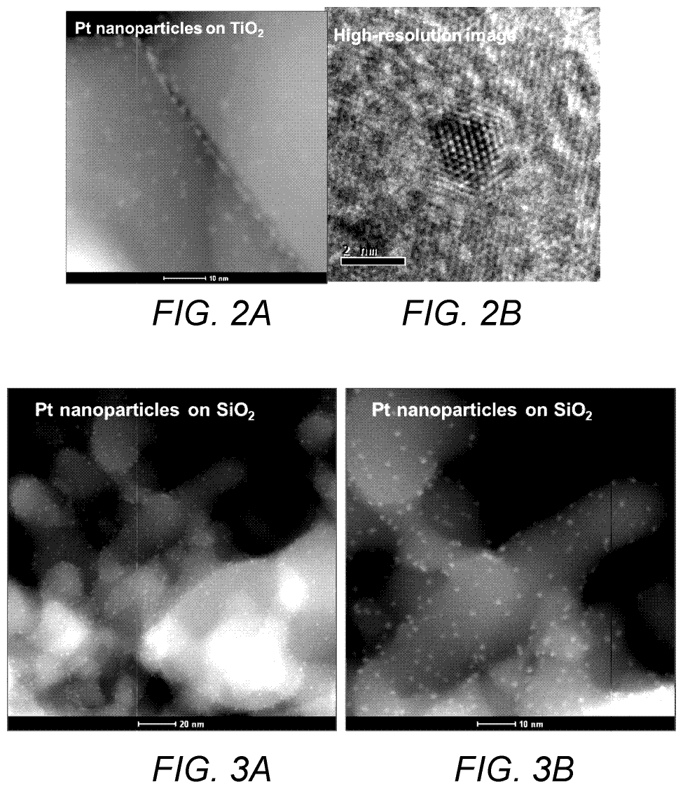

The Pt/TiO₂ catalysts prepared through the above methods had highly dispersed small crystalline Pt nanoparticles with the size of 1 to 2 nm and a metal atom dispersion of 40% to 60%. FIGS. 2A and 2B show representative electron transmission microscopic images of the Pt/TiO₂ catalysts.

### Examples 2(a)-2(e)

(Synthesis of Pt on low pore volume SiO₂ Catalysts)

SiO₂ (commercial silica, calcined at static air at 820° C. for 5 h, having a surface area of 17.2 m²/g, a pore volume of 0.22 cm³/g, and a median particle diameter (D₅₀) of less than 5 microns, 6 grams) was dispersed in deionized H₂O (60 mL). Ammonium hydroxide solution (30 wt. %, 0.78 mL) was added into the mixture, and the slurry stirred for 30 min. Tetraammineplatinum(II) chloride (106 mg) dissolved in H₂O (2 mL) was added into the slurry and then the mixture was stirred for 1.5 hrs. The resulting catalyst precursor/support material was separated from the slurry using vacuum filtration. The solid catalyst precursor/support material was washed (3 times) with deionized water (100 mL) and then dried in a drying oven at 95° C. for 3 hours to produce the catalyst precursor/support material as a dry powder. The catalyst precursor/support dry powder was reduced in a horizontal tube furnace using 10% H₂ balanced N₂ with a total flowrate of 500 standard cubic centimeter per min under the following conditions: a temperature rate of 10° C./min from 20° C. to 400° C. and keep at 400° C. for 1 hr before cooling to room temperature. The catalyst of the present invention had a Pt weight loading of 0.41 wt. % as determined by ICP anlysis. The particle size was 1 to 2 nm and the metal atom dispersion was 40% to 60%. FIGS. 3A and 3B show electron transmission microscopy images of the Pt nanoparticles on the SiO₂ support.

### Example 3

(Preparation of Pt on Low Pore Volume Al₂O₃ Catalysts)

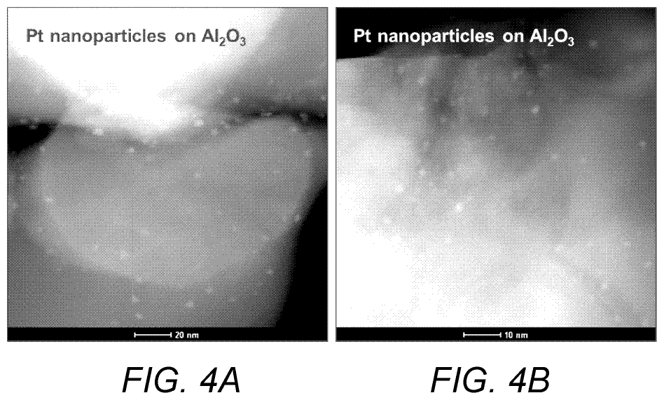

Al₂O₃ (having a specific surface area of 8.4 m²/g, a pore volume of 0.19 cm³/g, and a median particle diameter of less than 1 micron, 6 grams) was dispersed in deionized H₂O (60 mL). Hydrochloric acid (1.6 mL, 0.1 M HCl) was added into the mixture, and the slurry stirred for 30 min. H₂PtCl₆ (125 mg) dissolved in H₂O (2 mL) was added into the slurry and then mixture was stirred for 1.5 hrs. The resulting catalyst precursor/support material was separated from the slurry using vacuum filtration. The solid catalyst precursor/support material was washed (3 times) with deionized water (100 mL) and then dried in a drying oven at 95° C. for 3 hours to produce the catalyst precursor/support material as a dry powder. The catalyst precursor/support dry powder was reduced in a horizontal tube furnace using 10% H₂ balanced N₂ with a total flowrate of 500 standard cubic centimeter per min under the following conditions: a temperature rate of 10° C./min from 20° C. to 400° C. and keep at 400° C. for 1 hr before cooling to room temperature to produce the Pt/Al₂O₃ catalyst of the present invention. The final Pt loading was determined to be 0.17 wt. %, the Pt nanoparticles were 1 to 2 nm in size, and the metal atom dispersion was 40 to 60%. FIGS. 4A and 4B show representative electron transmission microscopic images of the Pt/Al₂O₃ catalysts.

### Example 4

(Preparation of Pt on Low Pore Volume Al₂O₃ Catalysts—Impregnation Method)

Al₂O₃ (having a specific surface area of 8.8 m²/g, a pore volume of 0.21 cm³/g, and a median particle diameter of less than 100 microns) was used in the impregnation preparation of Pt on low pore volume Al₂O₃. A H₂PtCl₆ stock solution Pt (3.6 wt. %) was prepared by dissolving H₂PtCl₆ in de-ionized H₂O. Then H₂PtCl₆ stock solution (0.7 g, 0.025 g Pt in the solution) was diluted with deionized H₂O (4.5 g). The diluted H₂PtCl₆ solution was added slowly to the Al₂O₃ (5.0 g), and the mixture was agitated and mixed to wet the solid and form a Pt catalyst precursor/Al₂O₃ composition. The Pt catalyst precursor/Al₂O₃ composition was dried in the oven overnight at 90° C. Then the dried sample was reduced in a horizontal tube furnace using 10% H₂ balanced N₂ with a total flow rate of 500 standard cubic centimeter per min under the following conditions: a temperature rate of 5° C./min from 20° C. to 200° C. and keep at 200° C. for 1 hr before cooling to room temperature to produce the 0.5 wt. % Pt/Al₂O₃ catalyst of the present invention.

### Example 5

(Preparation of Pt on Low Pore Volume Al₂O₃ Support)

Al₂O₃ (having a specific surface area of 8.8 m²/g, a pore volume of 0.21 cm³/g, and a median particle diameter of less than 100 microns) was used in the preparation of a catalyst of the present invention (Pt on low pore volume Al₂O₃). Al₂O₃ (6 g) were dispersed in deionized H₂O (60 mL). H₂PtCl₆ (125 mg) dissolved in H₂O (2 mL) was added into the slurry and then mixture was stirred for 2 hrs. The resulting catalyst precursor/support material was separated from the slurry using vacuum filtration. The solid catalyst precursor/support material was washed (3 times) with deionized water (100 mL) and then dried in a drying oven at 95° C. for 3 hours to produce the Pt catalyst precursor/Al₂O₃ support material as a dry powder. The Pt catalyst precursor/Al₂O₃ support dry powder was reduced in a horizontal tube furnace using 10% H₂ balanced N₂ with a total flowrate of 500 standard cubic centimeter per min under the following conditions: a temperature rate of 10° C./min from 20° C. to 400° C. and keep at 400° C. for 1 hr before cooling to room temperature to produce the Pt/Al₂O₃ catalyst of the present invention. The final Pt loading was determined to be 0.16 wt. %.

### Comparative Example A

(Preparation of Pt on High Pore Volume Al₂O₃ Catalyst—Impregnation Method)

Al₂O₃ (having a specific surface area of 103 m²/g, a pore volume of 0.55 cm³/g, and a median particle diameter of less than 100 microns) was used in the impregnation preparation of Pt on high pore volume Al₂O₃. A H₂PtCl₆ stock solution (3.6 wt. % Pt) was prepared by dissolving H₂PtCl₆ in de-ionized H₂O. Then the premade H₂PtCl₆ stock solution (0.7 g, 0.025 g Pt in the solution) was diluted with deionized H₂O (4.5 g). The diluted H₂PtCl₆ solution was added slowly to Al₂O₃ powder (0.5 g) and the mixture was agitated and mixed to wet the solid. The comparative catalyst precursor/support material was dried in the oven overnight at 90° C.

Then the dried comparative catalyst precursor/support material was reduced in a horizontal tube furnace using 10% H₂ balanced N₂ with a total flow rate of 500 standard cubic centimeter per min under the following conditions: a temperature rate of 1° C./min from 20° C. to 200° C. and keep at 200° C. for 1 hr before cooling to room temperature to produce the comparative Pt/Al₂O₃ material having a Pt loading of 0.5 wt. %.

### Comparative Example B

(Preparation of Pt on High Pore Volume Al₂O₃ Catalyst)

Al₂O₃ (having a specific surface area of 103 m²/g, a pore volume of 0.55 cm³/g, and a median particle diameter of less than 100 microns) was used in the preparation of Pt on high pore volume Al₂O₃. Al₂O₃ (6 g) was dispersed in deionized H₂O (60 mL). H₂PtCl₆ (125 mg) dissolved in H₂O (2 mL) was added into the slurry and then mixture was stirred for 2 hrs. The resulting comparative catalyst precursor/support material was separated from the slurry using vacuum filtration. The solid comparative catalyst precursor/support material was washed (3 times) with deionized water (100 mL) and then dried in a drying oven at 95° C. for 3 hours to produce the comparative catalyst precursor/support material as a dry powder. The comparative catalyst precursor/support dry powder was reduced in a horizontal tube furnace using 10% H₂ balanced N₂ with a total flowrate of 500 standard cubic centimeter per min under the following conditions: a temperature rate of 10° C./min from 20° C. to 400° C. and keep at 400° C. for 1 hr before cooling to room temperature to produce the comparative Pt/Al₂O₃ catalyst having a Pt loading of 1.0 wt. %.

### Comparative Example C

(Preparation of Pt on Al₂O₃ Extrudate Catalyst)

Extruded Al₂O₃ sphere beads (having a specific surface area of 2.2 m²/g, a pore volume of 0.01 cm³/g, sphere beads size 0.7 to 1.4 mm) was used in the preparation of Pt on Al₂O₃ extrudate. Al₂O₃ (6 g) was dispersed in deionized H₂O (60 mL). H₂PtCl₆ (125 mg) dissolved in H₂O (2 mL) was added into the slurry and then mixture was stirred for 2 hrs. The resulting comparative catalyst precursor/Al₂O₃ extrudate was separated from the slurry using vacuum filtration. The solid comparative catalyst precursor/Al₂O₃ extrudate was washed (3 times) with deionized water (100 mL) and then dried in a drying oven at 95° C. for 3 hours to produce the comparative catalyst precursor/Al₂O₃ extrudate as a dry powder. The comparative catalyst precursor/Al₂O₃ extrudate was reduced in a horizontal tube furnace using 10% H₂ balanced N₂ with a total flowrate of 500 standard cubic centimeter per min under the following conditions: a temperature rate of 10° C./min from 20° C. to 400° C. and keep at 400° C. for 1 hr before cooling to room temperature to produce the comparative Pt/Al₂O₃ extrudate catalyst having a Pt loading of 0.01 wt. %.

### Example 6

### (Physical Properties of Catalysts of the Present Invention and Comparative Catalysts)

The surface area, pore volume, and median particle diameter of the support material, catalysts of the present invention (Examples 1, 2 and 5) and the comparative catalysts (Comparative Example 7) were measured using the instrumentation described above under Testing Methodology and Instrumentation. The results are listed in Table 1. The Examples of the present invention (Examples 1, 2, and 5) had a surface area of 5 m²/g to 80 m²/g, a pore volume of 0.01 cm³/g to 0.35 cm³/g, and a catalyst median particle diameter (D₅₀) of less than 300 microns. In contrast, the comparative catalyst (Comparative Example B) had a surface area of 105 m²/g, a pore volume of 0.56 cm³/g and a median particle diameter of 52.6 microns.

TABLE 1

| | Support Material or | Surface | Pore | Median particle |
|---|---|---|---|---|
| | Catalyst/support | area | volume | diameter |
| Example | material | (m²/g) | (cm³/g) | (μm) |
| 1 | TiO₂ | 10.4 | 0.24 | 0.95 |
| 1 | Pt/TiO₂ | 10.4 | 0.20 | 0.72 |
| 2 | SiO₂ | 17.2 | 0.22 | 3.33 |
| 2 | Pt/SiO₂ | 21.8 | 0.27 | 2.82 |
| 5 | Al₂O₃ | 8.8 | 0.21 | 82.8 |
| 5 | Pt/Al₂O₃ | 9.1 | 0.26 | 53.5 |
| CE B | Al₂O₃ | 103 | 0.55 | 88.9 |
| CE B | Pt/Al₂O₃ | 105 | 0.56 | 52.6 |

### Example 7

### (Methods of Hydrogenation of Polystyrene)

The catalysts of the present invention (Examples 1(a) to 1(b), 2(a) to 2(e), 3, 4 and 5) and the comparative catalysts (Comparative Examples A, B and C) were used to hydrogenate polystyrene. A determined amount of the catalysts (typically in the range of 0.013 g to 0.780 g) was placed in a stainless reactor (Parr Series 5000 Multiple Reactor System, Parr Instrument Company, 100 mL) together with cyclohexane (30 mL, solvent) and polystyrene (PS-155, SABIC® (Saudi Arabia), average molecular weight M_{w}=235,000, 2 g). The reactor was purged first with N₂ for three times, and then with H₂ three times to remove air and moisture and the charged with high-pressure H₂ to the desired reaction pressure, about 500 and 1000 psi (3.4 MPa to 6.9 MPa). After the desired pressure has been reached the reactor content was heated to a set temperature between 140 and 200° C., at a rate of 1° C./min, and maintain at the final set temperature for a certain time, generally from 1 hr to 12 hr. After the reaction finished, the reactor was cooled to room temperature, the pressure discharged to atmospheric pressure (101 kPa), the contents in the reactor recovered, and the solid catalysts was separated from the polymer solution using centrifugation or filtration.

The conversion of aromatic rings was determined by comparing the Fourier Transfer Infrared (FT-IR) spectrum of the final polymer product using a FT-IR spectrometer (NICOLET iS50 FT-IR) with that of unsaturated polystyrene. The unsaturated aromatic rings showed a distinct IR absorptions at about 700 cm⁻¹ due to out-of-plane bends for the C—H bond attached to the aromatic rings. The conversion was 100% for the Pt catalysts of the present invention. The molecular weight of the final product was measured by gel permeation chromatography (GPC) and showed no scission of the polymer chains after the hydrogenation reaction. The catalytic hydrogenation results are tabulated in Table 2.

TABLE 2

| | | Catalyst | Reaction | H₂ | Reaction | | |
|---|---|---|---|---|---|---|---|
| | | Mass | Temp | Press. | time | Hydrogenation | Hydrogenation |
| Example | Catalyst | (g) | (° C.) | (psig) | (min) | activity^{(1, 2)} | level (%) |
| 1a | 0.33% Pt/TiO₂ | 0.78 | 140 | 1000 | 30 | 15 | 100 |
| 1b | 0.33% Pt/TiO₂ | 0.78 | 160 | 1000 | 15 | 30 | 100 |
| 2a | 0.41% Pt/SiO₂ | 0.26 | 140 | 1000 | 28 | 40 | 100 |
| 2b | 0.41% Pt/SiO₂ | 0.13 | 140 | 1000 | 60 | 36 | 100 |
| 2d | 0.41% Pt/SiO₂ | 0.067 | 160 | 1000 | 60 | 70 | 100 |
| 2d | 0.41% Pt/SiO₂ | 0.067 | 180 | 1000 | 25 | 169 | 100 |
| 2e | 0.41% Pt/SiO₂ | 0.067 | 200 | 1000 | 13 | 326 | 100 |
| 3 | 0.17% Pt/Al₂O₃ | 0.78 | 140 | 1000 | 36 | 24 | 100 |
| 4 | 0.50% Pt/Al₂O₃ | 0.78 | 140 | 1000 | 17 | 17 | 100 |
| 5 | 0.16% Pt/Al₂O₃ | 0.78 | 140 | 1000 | 30 | 31 | 100 |
| Comparative | 0.50% Pt/Al₂O₃ | 0.78 | 140 | 1000 | 120 | 2.5 | 100 |
| Ex . A | | | | | | | |
| Comparative | 1.0% Pt/Al₂O₃ | 0.78 | 140 | 1000 | 48 | 3.1 | 100 |
| Ex. B | | | | | | | |
| Comparative | 0.01% Pt/Al₂O₃ | 0.78 | 140 | 1000 | 280 | 2.0 | 4 |
| Ex. C | | | | | | | |

⁽¹⁾Polystyrene, M_{w} = 235,000 g/mol, PDI = 2.81, SABIC ®.
⁽²⁾Hydrogenation activity refers to as a measured rate of polymer hydrogenation, in the unit of moles of aromatic rings per hour per gram of Pt at a specific reaction temperature, pressure, and polymer concentration.

From these results, the catalysts of the present invention having 0.05 wt. % to 0.9 wt. % of catalytic metal nanoparticles that includes platinum (Pt), palladium (Pd), ruthenium (Ru), any combination thereof, or alloy thereof on a metal oxide support SiO₂, Al₂O₃, or TiO₂, or any combination thereof, and having a surface area of 5 m²/g to 80 m²/g, a pore volume of 0.01 cm³/g to 0.35 cm³/g, and a catalyst median particle diameter (D₅₀) of less than 300 microns had higher hydrogenation activity as compared to Comparative Example A (catalyst made through impregnation methods) and Comparative Example B (catalyst having a high pore volume). The examples of the present invention (Examples 1-5) had a higher hydrogenation activity and level than the extrude catalyst of Comparative Example 8. Thus, the catalysts of the present invention provide at least one solution to some of the problems associated with hydrogenating aromatic-containing polymers has been discovered. Such a catalyst can efficiently hydrogenate or partially hydrogenate aromatic containing polymers without causing polymer scission. The catalysts of the present invention are also cost-effective catalysts and have a low catalytic metal loading on a low pore-volume support.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

What is claimed is:

1. A catalyst for the hydrogenation of an aromatic containing polymer, the catalyst comprising, based on the total weight of the catalyst:
(a) 99.1 wt. % to 99.95 wt. % of a metal oxide support, and (b) 0.05 wt. % to 0.9 wt. % of catalytic metal nanoparticles comprising platinum (Pt), palladium (Pd), ruthenium (Ru), any combination thereof, or alloy thereof,
wherein the catalyst has a specific surface area of 5 m²/g to 80 m²/g, a pore volume of 0.01 cm³/g to 0.35 cm³/g, and a median particle diameter of less than 300 microns.

2. The catalyst of claim 1, wherein the catalyst has a surface area of 5 m²/g to 40 m²/g.

3. The catalyst of claim 1, wherein the catalyst has a pore volume of 0.03 cm³/g to 0.30 cm³/g.

4. The catalyst of claim 1, wherein the catalyst has a median particle diameter of less than 150 microns.

5. The catalyst of claim 1, wherein the metal oxide support comprises silica (SiO₂), alumina (Al₂O₃), or titania (TiO₂), or any combination thereof.

6. The catalyst of claim 1, wherein the catalytic metal nanoparticles have a size of 0.5 nm to 7 nm.

7. The catalyst of claim 1, wherein the dispersion of catalytic metal atoms on the nanoparticle surface is between on 30% to 80% with respect to the total metal atoms in the nanoparticle.

8. The catalyst of claim 1, wherein the catalyst comprises 0.05 wt. % to 0.8 wt. % of the catalytic metal nanoparticles, preferably 0.20 wt. % to 0.60 wt. % based on the total weight of the catalyst.

9. The catalyst of claim 1, wherein the catalytic metal nanoparticles are Pt nanoparticles.

10. The catalyst of claim 9, wherein the metal oxide support is TiO₂, SiO₂, Al₂O₃, or combinations thereof.

11. A method for the hydrogenation of an aromatic containing polymer, the method comprising contacting the catalyst of claim 1 with a polymer comprising at least one aromatic ring in the presence of hydrogen (H₂) gas under conditions sufficient to produce a polymer composition comprising at least one hydrogenated and/or at least one partially hydrogenated aromatic ring.

12. The method of claim 11, wherein the aromatic containing polymer is a polystyrene and the hydrogenated or partially hydrogenated polymer comprises poly(vinyl cyclohexane), and wherein the hydrogenated or partially hydrogenated polymer composition is free or substantially free of polymer scission compositions, and/or wherein contacting conditions comprise a temperature of 130° C. to 200° C.

13. A process to produce the catalyst of claim 1, the process comprising:
(a) contacting a slurry comprising 1) SiO₂ or TiO₂ metal oxide support in powder form, water, and a base, or 2) a Al₂O₃ metal oxide support in powder form, water, and an acid, with a catalytic metal precursor composition to produce a catalytic metal precursor/metal oxide support composition; and
(b) reducing the catalytic metal precursor/metal oxide support composition under conditions to produce the catalyst.

14. The process of claim 13, further comprising drying the catalytic metal precursor/metal oxide support composition prior to step (b) and wherein the reducing conditions comprise contacting the catalytic metal precursor/metal oxide support composition with H₂ at 250° C. to 450° C.

15. The process of claim 13, wherein the reducing conditions comprise adding a reducing agent to the catalytic metal precursor/metal oxide support composition to produce the catalyst, wherein the reducing agent is sodium borohydride or formaldehyde.

16. The process of claim 13, wherein the reducing conditions comprise adding a reducing agent to the catalytic metal precursor/metal oxide support composition to produce the catalyst, wherein the reducing agent is sodium borohydride or formaldehyde, and wherein the catalytic metal precursor comprises a platinum salt, a palladium salt, or a ruthenium salt, and wherein the base comprises ammonium hydroxide or a metal hydroxide and the acid comprises hydrochloric acid or nitric acid.

17. The process of claim 13, wherein the reducing conditions comprise adding a reducing agent to the catalytic metal precursor/metal oxide support composition to produce the catalyst, wherein the catalytic metal precursor comprises a platinum salt, a palladium salt, or a ruthenium salt, and wherein the base comprises ammonium hydroxide or a metal hydroxide and the acid comprises hydrochloric acid or nitric acid.

18. A catalyst for the hydrogenation of an aromatic containing polymer, the catalyst comprising, based on the total weight of the catalyst:
(a) 99.1 wt. % to 99.95 wt. % of a metal oxide support in powder form, and
(b) 0.05 wt. % to 0.9 wt. % of catalytic metal nanoparticles comprising platinum (Pt), or alloy thereof,
wherein the catalyst has a specific surface area of 5 m²/g to 80 m²/g, a pore volume of 0.01 cm³/g to 0.35 cm³/g, and a median particle diameter of less than 300 microns,
wherein Brunauer-Emmett-Teller (BET) N₂-adsorption measurements are performed at 77 K to characterize the surface area and pore volume;
wherein the mean particle diameter of the supports is performed on a dynamic light scattering instrument, and
wherein the amount of catalytic metal in the catalyst is determined using inductively coupled plasma atomic emission spectroscopy.

19. A process to produce the catalyst of claim 1, the process comprising:
(a) contacting a slurry comprising 1) SiO₂ or TiO₂ metal oxide support in powder form, water, and a base, or 2) a Al₂O₃ metal oxide support in powder form, water, and an acid, with a catalytic metal precursor composition to produce a catalytic metal precursor/metal oxide support composition; and
(b) reducing the catalytic metal precursor/metal oxide support composition under conditions to produce the catalyst of any one of claims 1 to 10, and (c) drying the catalytic metal precursor/metal oxide support composition prior to step (b) and wherein the reducing conditions comprise contacting the catalytic metal precursor/metal oxide support composition with H₂ at 150° C. to 600° C.

20. The process of claim 18, wherein the reducing conditions comprise adding a reducing agent to the catalytic metal precursor/metal oxide support composition to produce the catalyst, wherein the reducing agent is sodium borohydride or formaldehyde, and/or wherein the catalytic metal precursor comprises a platinum salt and wherein the base comprises ammonium hydroxide or a metal hydroxide and the acid comprises hydrochloric acid or nitric acid.
